(19) United States
(12) Patent Application Publication
(10) Pub. No.: US 2004/0247853 A1
(43) Pub. Date: Dec. 9, 2004

(54) Laminated vehicle body component and method of manufacturing

(76) Inventors: Matthias Ludwig, Vechelde (DE); Marcus Lutz, Gifhorn (DE); Frank Niebuhr, Wilsche (DE); Tobias Niesner, Wolfsburg (DE); Harald Batke, Gerstenbuttle (DE)

Correspondence Address: CARLSON, GASKEY & OLDS, P.C., 400 WEST MAPLE ROAD, SUITE 350, BIRMINGHAM, MI, 48009, US

(21) Appl. No.: 10/854,914

(22) Filed: May 27, 2004

(30) Foreign Application Priority Data
Jun. 3, 2003 (DE) 103 25 096.4

(51) Int. Cl. B32B 1/04; B32B 3/02; B32B 3/26; B32B 3/00

(52) U.S. Cl. 428/304.4; 428/313.5

(57) ABSTRACT

A laminated component, in particular a vehicle body part, includes a substrate and a plastic layer disposed on the substrate. Shrinkage-resistant displacement bodies are embedded in the plastic layer to prevent shrinkage of the plastic layer when it is reacted and cured.

### REFERENCE TO RELATED APPLICATIONS

The present application claims the benefit of German Patent Application No. 103 25 096.4, filed Jun. 3, 2003.

### TECHNICAL FIELD

The invention relates to a laminated component, and in particular a body part for a motor vehicle, comprising a substrate and a plastic layer connected to the substrate.

### BACKGROUND OF THE INVENTION

A vehicle body part, such as a roof module, may be manufactured as a laminated component having a substrate and a plastic layer disposed on the substrate. The substrate may be a foil made of, for example, thermoplastic material or aluminum. The plastic layer may be formed from a liquid plastic, such as polyurethane, disposed on the substrate. Glass fibers may be added to the liquid plastic before it is applied to the substrate. The substrate and the liquid plastic are introduced into a foaming mold in which the liquid plastic expands and solidifies to form the plastic layer of the laminated component. The resulting laminated component is a composite part having high strength and comparably low weight.

As is known in the art, heat is generated during curing of the liquid plastic. Areas where the plastic layer is thicker will generate more local heat than areas where the plastic layer is thinner. This creates uneven heat distribution over the laminated component, causing the material in the plastic layer to shrink unevenly when the laminated component cools. This uneven shrinking creates cavernous or recessed areas in the material. These areas may be visible on an outer side of the substrate, which faces away from the plastic layer, as surface defects. This is particularly apparent when a comparably thin foil is used as the substrate.

There is a desire to avoid surface defects in a laminated component due to uneven heat generation and shrinking in the plastic layer.

### SUMMARY OF THE INVENTION

The invention is a laminated component that includes shrinkage-free or low-shrinkage displacement bodies embedded in a plastic layer of the laminated component. The displacement bodies reduce a total amount of plastic material used in the plastic layer, thereby reducing the adverse effects, such as surface defects, caused by shrinking in the plastic material. In one embodiment, the displacement bodies are bodies that are temperature stable and mechanically stable and that have a defined volume and virtually no weight. These characteristics allow the bodies to be readily embedded in the plastic layer.

Advantageous designs of the invention will be apparent from the sub-claims.

### BRIEF DESCRIPTION OF THE DRAWINGS

The invention will be described in the following with the aid of a preferred embodiment illustrated in the attached drawings in which:

FIG. 1 is a schematic, broken cross-sectional view of a laminated component according to one embodiment of the invention; and

FIG. 2 is a schematic view of a device for manufacturing the laminated component according to one embodiment of the invention.

### DETAILED DESCRIPTION OF THE EMBODIMENTS

The invention is generally directed to a laminated component that can be used as, for example, a vehicle body part. The laminated component includes a plurality of shrinkage-resistant (which includes shrinkage-free) displacement bodies embedded in a plastic layer of the laminated component. The displacement bodies reduce the total amount of plastic material used to form the plastic layer, thereby reducing the amount of material subject to shrinkage. As a result, the likelihood of surface defects caused by shrinking plastic material is also reduced. In one embodiment, the displacement bodies are temperature-stable, mechanically stable, and have a defined volume and virtually no weight, allowing them to be readily embedded in the plastic layer.

In one embodiment, the displacement bodies have a specific weight that is lower than a specific weight of the plastic material forming the plastic layer. This results in a lower overall weight of the laminated component, which is highly desirable.

The displacement bodies may be irregularly distributed in the plastic layer, with a larger number of displacement bodies disposed in thicker areas of the plastic layer than in thinner areas. This irregular displacement body distribution addresses two issues. First, shrinkage in the plastic layer becomes increasingly severe as more plastic material is used in a given area of the plastic layer (e.g., as the plastic layer becomes thicker). Thus, it is advantageous to use more displacement bodies in thicker areas. Second, it is preferable to use a smaller number of displacement bodies in thinner areas of the plastic layer due to the reduced amount of plastic material, and consequently the reduced plastic layer strength, in those areas. Because the displacement bodies tend to weaken the plastic layer somewhat, keeping a larger number of displacement bodies in areas having more plastic material (i.e., in the thicker, higher-strength areas) preserves the overall strength of the laminated composite.

In one embodiment, the displacement bodies are made of plastic. The displacement bodies may have a hollow interior or a foamed interior, for example. Preferably, the displacement bodies have closed surfaces to prevent plastic material in the plastic layer from penetrating the displacement bodies. The displacement bodies should also be made from a temperature-stable material to prevent the displacement bodies from reacting with the plastic material during curing. The displacement bodies may be made of, for example, recycled polyurethane material.

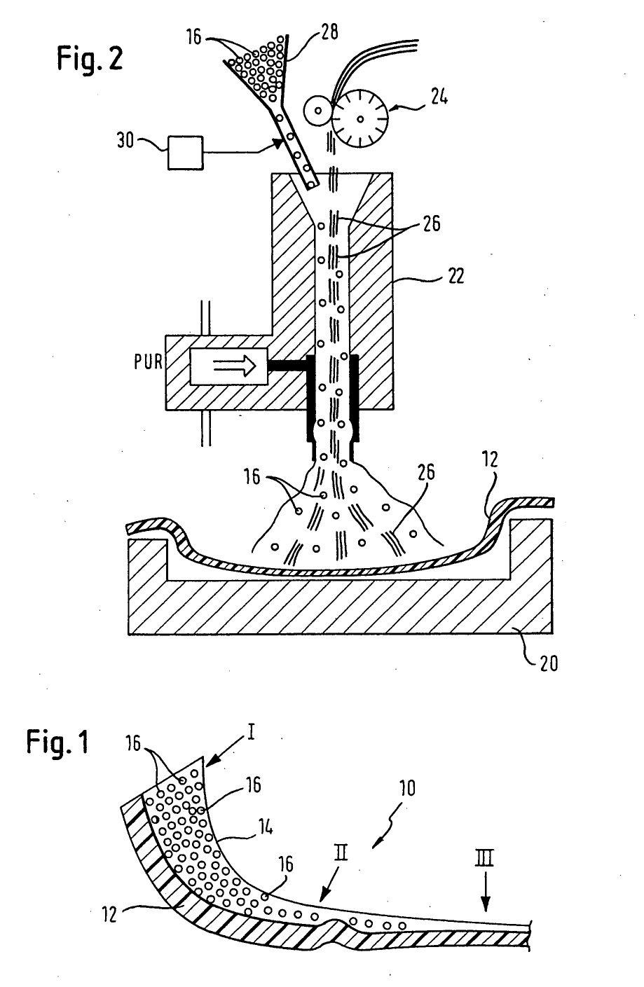

Referring to the figures, FIG. 1 illustrates a laminated component 10 comprising a substrate 12 and a plastic layer 14 applied on the substrate 12. The substrate 12 is a foil made of, for example, a thermoplastic material or any other appropriate material (e.g., aluminum, aluminum alloy, composites, etc.). The plastic layer 14 is a foamed plastic material, such as foamed polyurethane. In one embodiment, the plastic layer 14 may be reinforced with fibers, such as glass fibers, via any known method. Note that the plastic layer 14 may also be formed through other methods, such as injection molding, without departing from the scope of the invention.

A plurality of small displacement bodies 16 are embedded in the plastic layer 14. In one embodiment, the displacement bodies 16 are made of plastic and have closed surfaces to prevent penetration of the plastic material from the plastic layer 14 into the displacement bodies 16. It is important that the displacement bodies 16 are not homogeneously distributed throughout the plastic layer 14. Instead, the displacement bodies 16 should be distributed in proportion with the respective thicknesses of the plastic layer 14 in different areas. In an area of the plastic layer 14 referenced by numeral I in FIG. 1, where the thickness of the plastic layer 14 is large, the proportion of displacement bodies 16 with respect to the plastic material in that area is relatively high to accommodate the increased thickness. In an area of the plastic layer 14 referenced by numeral II, where the plastic layer 14 has a medium thickness, the proportion of displacement bodies 16 in that area is less than in the area referenced by numeral I due to the reduced thickness. Similarly, in an area referenced by numeral III, where the plastic layer 14 is particularly thin, no displacement bodies 16 are included at all.

One possible method for manufacturing the laminated component 10 shown in FIG. 1 will now be described with reference to FIG. 2.

During manufacturing, a molded blank of the substrate 12 is placed in a lower part 20 of a foaming mold. Liquid plastic, such as liquid polyurethane, is applied on the substrate 12 via a mixing head 22. This mixing head 22 can be moved relative to the lower part 20 of the foaming mold so that the liquid plastic can be distributed on the substrate 12 in a desired manner. A cutting tool 24 may be provided above the mixing head 22 to cut reinforcing fibers 26 to a desired length. A storage container 28 holds the displacement bodies 16 and a dosing device 30 controls a rate at which the displacement bodies 16 are dispensed into the lower part 20 of the foaming mold.

The liquid plastic is applied on the substrate 12 by moving the mixing head 22 across the substrate 12. Depending on the position of the mixing head 22 and the desired thickness of the plastic layer 14, the dosing device 30 supplies a higher or lower portion of displacement bodies 16 to the mixing head 22 to control the number of displacement bodies 16 deposited on any given area of the substrate 12.

After the liquid plastic has been applied on the substrate 12, the foaming mold is closed by placing an upper part of the foaming mold (not shown) on the lower part 20. The liquid plastic then reacts and cures to form the plastic layer 14. Because the displacement bodies 16 do not shrink when the liquid plastic is curing, the displacement bodies 16 reduce shrinkage in the resulting plastic layer 14 to a degree corresponding to the proportion of displacement bodies 16 in any given area of the plastic layer 14. For example, areas having fewer displacement bodies 16 with respect to the amount of plastic material may potentially experience more shrinkage; however, because these areas also tend to be thinner, the total amount of shrinkage in these areas may be extremely limited or non-existent. Thus, the lack of displacement bodies 16 in thinner areas of the plastic layer 14 does not adversely affect surface quality of the laminated component 10.

It should be understood that various alternatives to the embodiments of the invention described herein may be employed in practicing the invention. It is intended that the following claims define the scope of the invention and that the method and apparatus within the scope of these claims and their equivalents be covered thereby.

1. A laminated component for a vehicle body part, comprising:
a substrate;
a plastic layer formed from a plastic material disposed on the substrate; and
a plurality of displacement bodies distributed in the plastic layer, wherein the plurality of displacement bodies are made from a shrinkage-resistant material.

2. The laminated component according to claim 1, wherein each of the plurality of displacement bodies has a specific weight that is lower than a specific weight of the plastic material in the plastic layer.

3. The laminated component according to claim 1, wherein the displacement bodies are distributed irregularly in the plastic layer.

4. The laminated component according to claim 3, wherein the plastic layer includes areas of differing thickness, and wherein a thicker area of the plastic layer has a higher proportion of displacement bodies than a thinner area of the plastic layer.

5. The laminated component according to claim 1, wherein the substrate is a foil made of a thermoplastic material.

6. The laminated component according to claim 1, wherein the substrate is a foil containing aluminum.

7. The laminated component according to claim 1, wherein the plastic layer comprises a foamed material.

8. The laminated component according to claim 1, wherein the plastic layer comprises polyurethane.

9. The laminated component according to claim 1, wherein the plurality of displacement bodies are made of plastic.

10. The laminated component according to claim 1, wherein the plurality of displacement bodies are hollow.

11. The laminated component according to claim 1, wherein the plurality of displacement bodies comprise foamed material.

12. The laminated component according to claim 1, wherein the plurality of displacement bodies have closed surfaces.

13. The laminated component according to claim 1, wherein the plurality of displacement bodies are made from a temperature-stable material.

14. A method of manufacturing a laminated component, comprising:
placing a substrate in a lower part of a mold;
mixing liquid plastic with a plurality of displacement bodies; and
depositing the liquid plastic and the plurality of displacement bodies onto the substrate; and
curing the liquid plastic to form a plastic layer.

15. The method of claim 14, further comprising mixing the liquid plastic with a plurality of reinforcing fibers before the depositing step.

16. The method of claim 14, further comprising controlling a rate at which the plurality of displacement bodies are mixed with the liquid plastic to vary a proportion of displacement bodies in the liquid plastic.

17. The method of claim 16, wherein the controlling step increases the proportion of displacement bodies in areas where the plastic layer is to be thicker and decreases the proportion of displacement bodies in areas where the plastic layer is to be thinner.
